(19) United States
(12) Patent Application Publication
(10) Pub. No.: US 2022/0127017 A1
(43) Pub. Date: Apr. 28, 2022

(54) A FLOATING PLATFORM FOR LAUNCHING A SPACE ROCKET FROM A HEIGHT AND METHOD FOR LAUNCHING A RIGID -WALLED BALLOON INTO THE SPACE

(71) Applicant: Szabolcs TAKÁCS, Fuzesabony (HU)

(72) Inventor: Szabolcs TAKÁCS, Fuzesabony (HU)

(21) Appl. No.: 17/437,916

(22) PCT Filed: Mar. 10, 2020
(86) PCT No.: PCT/HU2020/050007

§ 371 Date: Sep. 10, 2021

(30) Foreign Application Priority Data
Mar. 21, 2019 (HU) P1900085

(51) Int. Cl. B64G 1/00; B64B 1/54; B64B 1/58

(52) U.S. Cl. CPC B64G 1/005; B64B 1/58; B64B 1/54

(57) ABSTRACT

The subject of the present invention relates to a floating platform (10) for launching a space rocket (100) from high altitude comprising a support structure (20) for suspending the space rocket (100) and which support structure (20) can be releasably connected to the space rocket (100), one or more hydrogen or helium filled balloons (30) fixed to the support structure (20), one or more rigid-walled tanks (12) and a compressor module (40) connected to the one or more balloons (30) and rigid-walled tanks (12) for delivering at least a portion of the hydrogen or helium stored in the balloons (30) into the one or more rigid-walled tanks (12), said one or more balloons (30) are dimensioned to lift the floating platform (10) and the space rocket (100) connected thereto, characterized in that the floating platform (10) comprises a hydrogen or helium-filled, preferably cigar-shaped rigid-walled balloon (35) which is releasably connected to the support structure (20) and secured to the top of the space rocket (100) and which is suitable for connecting the space rocket (100) to the support structure (20). The invention further relates to a method for launching a rigid-walled balloon (35) into space.

The present invention relates to a floating platform for launching a space rocket from high altitude.

The present invention also relates to a method for launching a rigid-walled balloon to space.

Currently, space rocket is the only known device that can deliver payloads or humans to space. A space rocket (or simply a rocket) is a reactive device in which thrust is provided by a high velocity gas produced by the combustion of solid or liquid propellant.

Space rockets are most often launched from sea level, ground-based space centers (e.g. Cape Canaveral, Kennedy, Baikonur, etc.), or from sea launch stations (e.g. Sea Lunch). The atmosphere exerts a braking force (air drag) to the launched rocket which is proportional to the square of the velocity of the rocket. Since the rocket is already traveling at very high speeds in the lower parts of the atmosphere, the braking effect of the atmosphere is significant, thus, a huge portion of the fuel is used to compensate for the air resistance of the atmosphere. Therefore, a rocket launched from sea level needs a lot of fuel, so the rocket itself must be large, which significantly increases the cost of launching.

As is known, as the altitude increases the density of the air decreases. About 80% of the mass of the atmosphere is below 18 km above sea level. Most of the air resistance on the rocket, therefore, occurs during transit across the troposphere and the bottom of the stratosphere. That is, the negative effect of air resistance can be significantly reduced by launching a rocket from high altitude.

Rockets being launched from aircrafts have been used for decades to launch small satellites into low Earth orbit (LEO). An example of such a rocket is the Pegasus, developed by Orbital Sciences Corporation, which is a three-stage solid booster. The launching takes place in two phases. As a first step, the Pegasus (for example, with the help of a Lockheed L-1011 aircraft) is brought to an altitude of 12 km. During the second phase, the rocket is released and the rocket engine is ignited after reaching the desired height. The advantage of this solution is that smaller rockets are needed to bring a given payload to space, thus costs can also be reduced. The disadvantage of this solution is that the size of the rocket is significantly limited by the carrying capacity of the carrier aircraft, which means that only a few hundred kg (up to 443 kg in the case of Pegasus) can be launched into space.

Another way to launch rockets from the atmosphere is to lift the rocket to an altitude of several kilometers using an inflatable balloon, then release it from the balloon and start the engines. One of these, the so-called rockoon has been disclosed in the U.S. Patent Application No. 2018/0290767. The concept of this solution is to attach a suitably sized inflatable balloon to a specially designed (flat) multi-stage rocket to lift the rocket to an altitude of 20-30 km. Once the desired height is reached, the rocket is released, the engines are ignited, and the rocket is set to orbit normally. The advantage of this solution is that the launch of the rocket from high altitude can save a significant amount of fuel (the traditional first stage is practically omitted), thus a smaller rocket is needed to launch a specific payload. Another advantage is that, due to the weaker atmosphere, rocket shapes and engines that are different from traditional rockets can be designed. Rocket nozzles designed for lower atmospheric pressures are larger, and therefore more efficient and less expensive. Because weather effects are mainly limited to the troposphere (atmosphere below about 10 km), rocket launches above the troposphere are virtually unaffected by weather conditions, thus the cost of postponing conventional launches can be saved.

The disadvantage of current rockoon solutions is that they are capable of delivering only a lightweight rocket, thus a small payload, to outer space. Another disadvantage is that the gas in the balloon (e.g. hydrogen, helium) is simply released after the launch or left to lose with the balloon. These two drawbacks are related, since current rockoon systems are specifically designed for small rockets. Accordingly, the size of the required balloon does not justify reusing the gas contained in the balloon or the balloon itself. In case of the current solutions, there is no launch platform. A further disadvantage is that in the present solutions, the position and movement of the rockoon are substantially determined by the wind, which makes it difficult to launch.

Some of the above problems are overcome by the solution described in US 2005/0116091, which discloses a multi-component platform for launching a space rocket from high altitude. The main components of the system are one or more helium-filled oblong airships, a tank-holding module connected to the airships containing a rigid tank and a compressor, and a winged rocket platform. The gist of this solution is to lift the rocket to high altitude using the platform and then accelerate the entire system to a horizontal speed of several hundred or thousands of kilometers per hour before launching the rocket.

U.S. Pat. No. 6,119,883 discloses a space rocket with a rigid-walled balloon attached to the top of it. After takeoff, the unit rises as an airship due to the hydrogen stored in the rigid-walled balloon and then rises as a rocket using the stored hydrogen as fuel.

While the above solutions are capable of launching rockets from a height, they do not allow the launch of the rigid-walled balloons (and a significant amount of gas contained in them) into space.

The inventor has realized that there is currently no reusable floating platform capable of launching rockets for carrying tons of payloads into space. It has also been discovered that in current rockoon systems, the balloon or gas in the balloon is not recycled after launching, which increases costs and, due to the disposable design, limits the size of the rocket to be launched.

The inventor has realized that, after launching a rocket, the gas contained in the balloons can be pumped into rigid-walled tanks, thus being reusable later, and the balloon can be returned to the ground as planned. Because units other than the rocket can now be reused, floating platforms that contain larger-than-ever balloons can be provided and economically operated and with which larger-scale rockets can be launched from high altitude.

It has also been realized that there is currently no method for delivering a rigid-walled balloon and the gas contained therein into space, which balloon is comparable to a carrier rocket, or larger. The inventor has have realized that many applications of a rigid-walled balloon and the gas stored therein, especially hydrogen, are possible in outer space (see below). The inventor has also realized that the floating platform of the present invention enables the launch of such a rigid-walled balloon and the gas stored therein into space.

It is an object of the present invention to provide an apparatus and method that is free from the disadvantages of the prior art. In particular, our goal is to create a floating platform that can deliver payloads (or humans) to space at a lower cost than at present, or to deliver a rigid-walled balloon to space. The objects of the present invention are achieved by the floating platform according to claim 1 and the method of claim 12.

Preferred embodiments of the invention are defined in the dependent claims.

Further details of the invention will be shown by way of example in the drawings. In the drawings

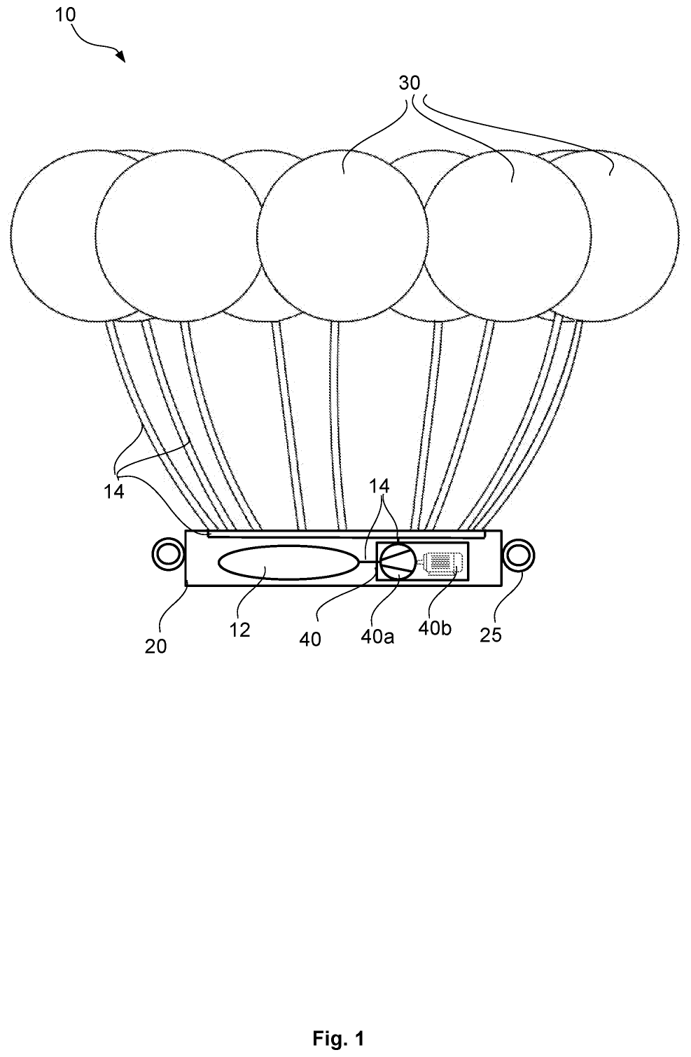

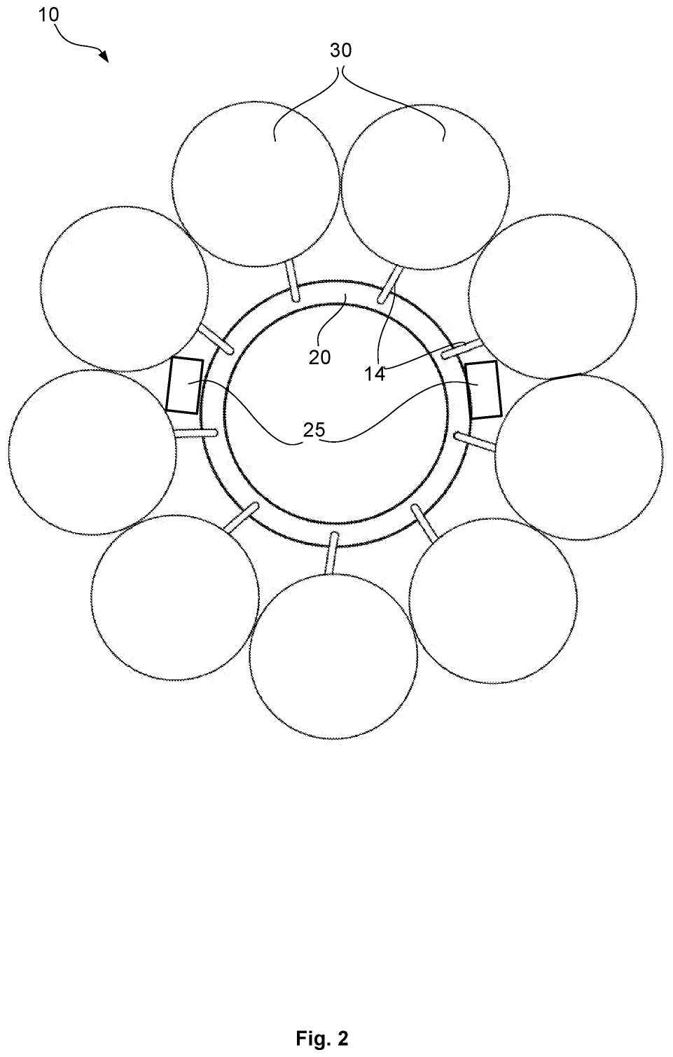

FIG. 1 is a schematic, not scale, partially sectional side view of an exemplary embodiment of a floating platform according to the invention,

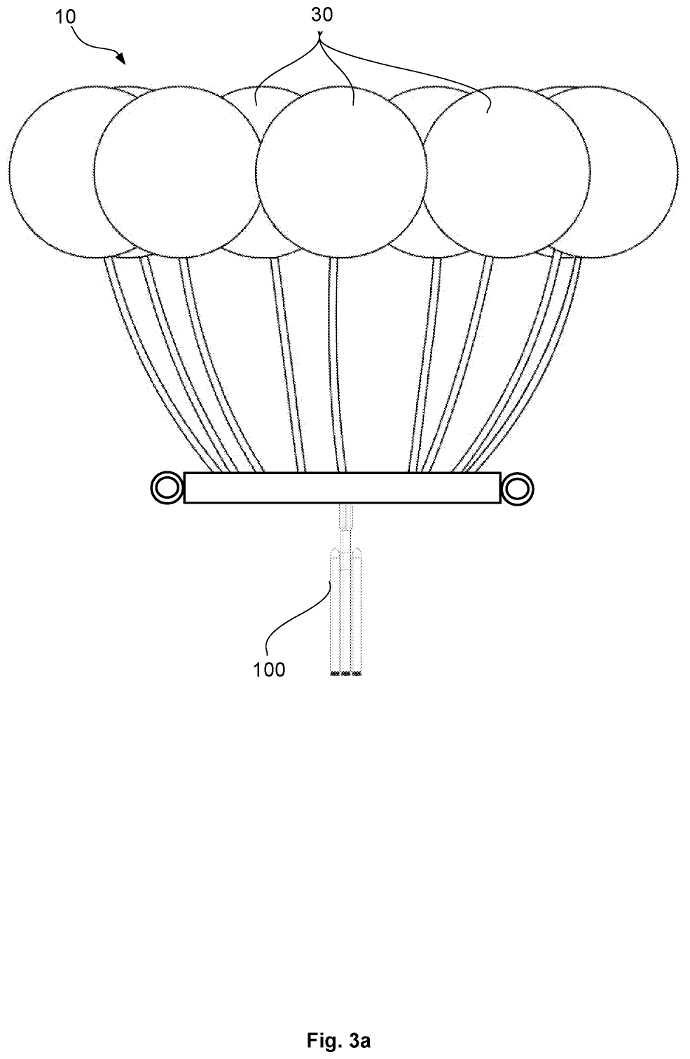

FIG. 2 is a top view of the platform shown on FIG. 1,

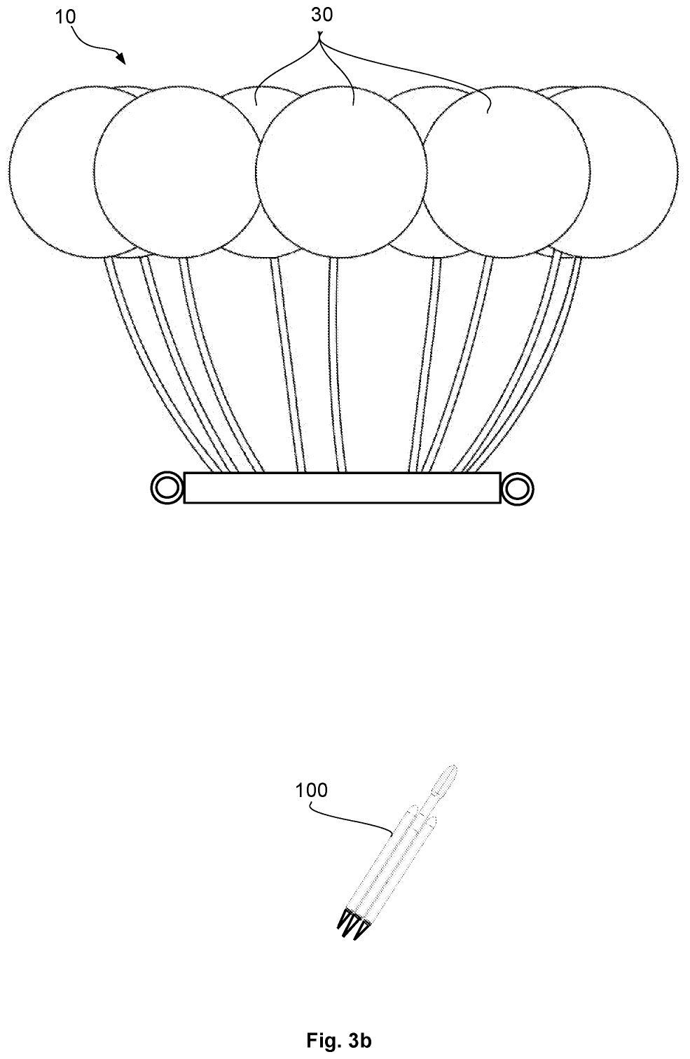

FIG. 3a is a schematic view of an exemplary embodiment of a rigid-walled balloon of a floating platform according to the present invention in space-rocket coupled state,

FIG. 3b is a schematic view showing the floating platform shown in FIG. 3a after the space rocket has been released,

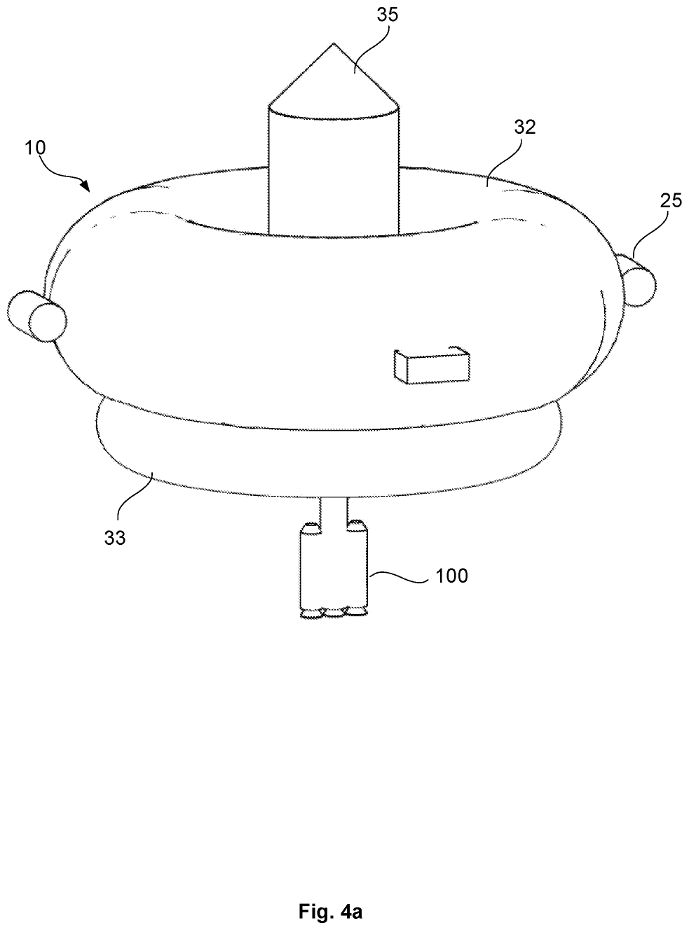

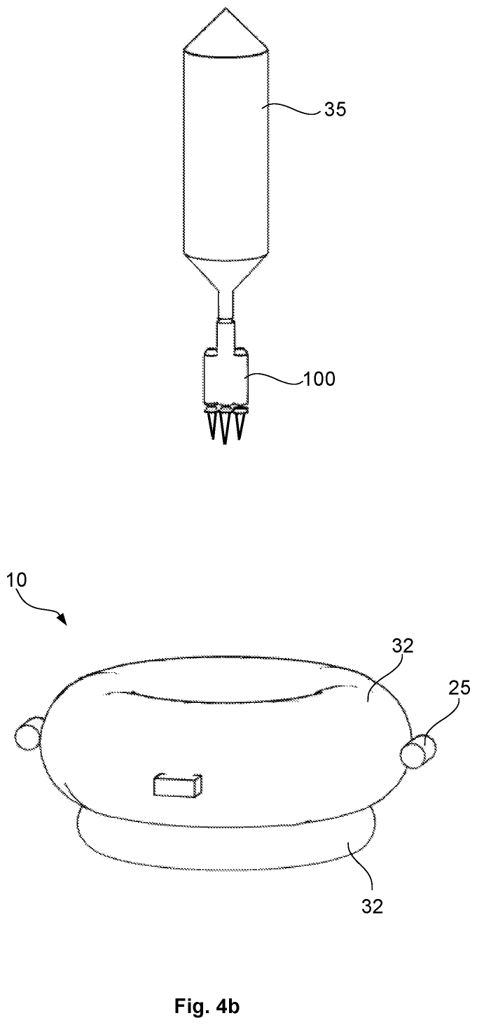

FIG. 4a is a schematic view of another exemplary embodiment of a rigid-walled balloon of a floating platform according to the invention in space-rocket-coupled state,

FIG. 4b is a schematic view showing the floating platform shown in FIG. 4a after the space rocket has been released,

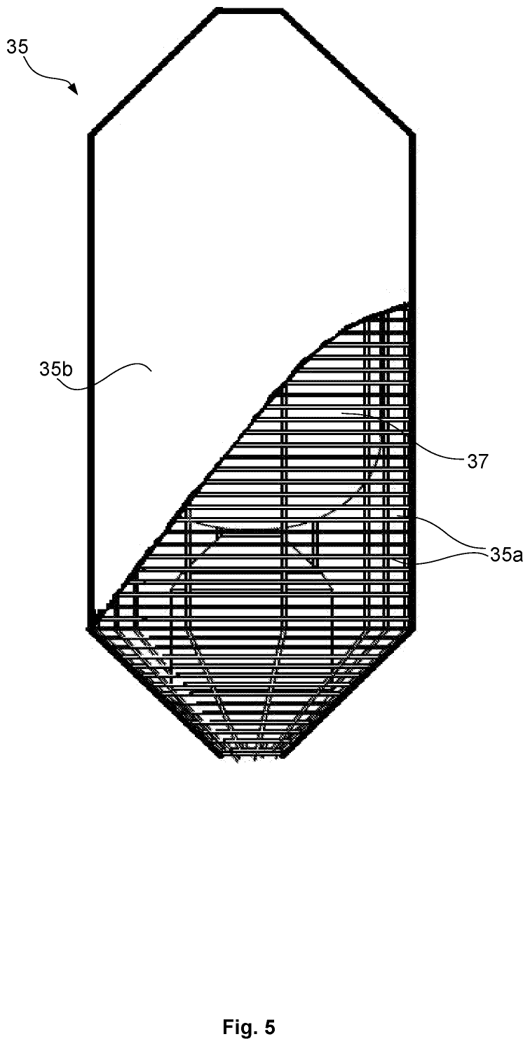

FIG. 5 is a schematic view showing the main structural elements of an exemplary rigid-walled balloon.

FIGS. 1 and 2 are schematic, non-scaled side and top views of an exemplary embodiment of the floating platform 10 of the present invention. The platform 10 is adapted to launch space rockets 100 from an altitude (several kilometers above sea level). In the context of the present invention, space rocket 100 refers to a device which works on reactive principle as previously described, with a solid or liquid propellant, such as a known type of rocket (Falcon, Atlas, Delta, etc.) or a rocket specially designed to be launched from the atmosphere in the future.

The platform 10 of the present invention comprises a support structure 20 which is removably coupled to the rocket 100, and which is suitable for hanging the rocket 100, and one or more balloons 30 filled with hydrogen or helium attached to the support structure 20. The support structure 20 is designed to transmit the lifting force of one or more balloons 30 to the space rocket 100 releasably attached to the support structure 20. It is noted that in the case of a releasable attachment, an additional element is inserted between the space rocket 100 and the support structure 20 (see below, rigid balloon 35) and that the releasable attachment is provided thereby. The support structure 20 is made of a material having sufficient strength and which is preferably lightweight, such as carbon fiber, other composite material or metal alloy, in order to suspend the space rocket 100 in the air, as will be apparent to those skilled in the art. In a preferred embodiment, the support structure 20 is ring-shaped, and the balloons 30 are equally spaced along the circumference of the ring, as shown, for example, in FIG. 2. It is noted that other embodiments may be conceivable in which the support 20 is not circular but polygonal, for example. The balloons 30 are made of a resilient material, such as reinforced-wall latex, which withstands extreme temperature and pressure conditions in the upper layers of the atmosphere and which, when expanded, has a uniform thickness. For example, the one or more balloons 30 may be spherical or droplet shaped (as the ones used as meteorological balloons), which balloons 30 are dimensioned in such as to lift the floating platform 10 and its associated space rocket 100. In a particularly preferred embodiment, the one or more balloons 30 are dimensioned to raise the floating platform 10 and its associated space rocket 100 to an altitude of at least 10.000 to 30.000 meters.

The platform 10 of the present invention further comprises one or more rigid-walled tanks 12 and a compressor module 40 connected to the one or more balloons 30 and to the rigid-walled tanks 12 for delivering at least a portion of the hydrogen or helium stored in the balloons 30 into the one or more rigid-walled tanks 12, as shown, for example, in FIG. 1. Preferably, the one or more rigid-walled tanks 12 are made of metal (e.g., aluminum or steel) and are connected to the one or more balloons 30 through the compressor module 40 via a pressure-tight pipeline 14. Preferably, the one or more rigid-walled tanks 12 are secured to the support structure 20. In one embodiment, the support structure 20 is hollow and the one or more rigid-walled tanks 12 and preferably the compressor module 40 are arranged within the support structure 20.

Compressor module 40 includes one or more compressors 40a for transporting hydrogen or helium gas into the balloon 30 through the pipeline 14, and for boosting gas pressure and reducing gas volume, and drive unit 40b for operating the compressor 40a. The compressor 40a may be any known type of compressor (e.g., piston compressor) suitable for pumping at least a portion of the hydrogen or helium in the one or more balloons 30 into the rigid-walled tank 12. The drive unit 40b may be, for example, a battery-driven electric motor or an internal combustion engine as known to those skilled in the art.

In a particularly preferred embodiment shown in FIGS. 4a and 4b, one or more balloons 30 are arranged inside a rigid toroidal-shaped first housing 32, and the one or more rigid-walled tanks 12 and the compressor module 40 are arranged inside a torus-shaped rigid second housing 33. In this embodiment, the first and second housings 32, 33 are arranged in contact with one another, fixed to each other. The first and second housings 32, 33 preferably comprise frame structures defining the shape of the first and second housings, preferably made of carbon fiber, and further comprise outer covers (shells), made of Kevlar, covering the frame structures. In this embodiment, the first and/or second housings 32, 33 may both serve as a supporting structure 20, i.e. the space rocket 100 may optionally be secured to the first and/or second housings 32, 33.

In a particularly preferred embodiment, one or more propulsion engines 25 for maneuvering the floating platform 10 are attached to the support structure 20. In the embodiments comprising the first and second torus-shaped housings 32, 33, the propulsion engine 25 can be secured, for example, to the housings 33 or 32, as shown, for example, in FIG. 4a. It is noted that in the context of the present invention, maneuvering means the ability to rotate the platform 10 horizontally and/or vertically. The propulsion engine 25 may be, for example, a propeller engine, a propeller gas turbine, or a jet engine for moving the platform 10 in the desired direction. The platform 10 may advantageously be provided with a navigation module (e.g., a GPS module) for determining the geographical position of the platform 10, and with a central IT unit for controlling the one or more propulsions engines 25 connected to the navigation module. Preferably, the central IT unit is a computer capable of controlling the one or more propulsion engines 25 based on, for example, a navigation module signal or a wireless signal (e.g., a radio signal) from a ground control center.

In the embodiment shown in FIG. 3a, the platform 10 of the present invention comprises a hydrogen or helium filled, preferably cigar-shaped, rigid-walled balloon 35, releasably attached to the support structure 20 and secured to the top of the rocket 100, and the space rocket 100 is connected to a support structure 20 through the rigid-walled balloon 35. Preferably, the support structure 20 is dimensioned to surround the rigid balloon 35 circumferentially (see FIG. 3a). That is, the space rocket 100 is secured to the support structure 20 through the rigid-walled balloon 35. The rigid-walled balloon 35 comprises a frame 35a, preferably made of carbon fiber, defining the shape of the rigid-walled balloon 35, one or more inner balloons 37 filled with hydrogen or helium, and an outer shell 35b, preferably made of Kevlar, covering the rigid frame 35a, as shown in FIG. 5. The outer shell 35b may, of course, be made of other materials of suitable density and strength, such as composite, as will be apparent to those skilled in the art. One or more inner balloons 37 may also be made of latex. It is noted that in the context of the present invention, rigid-walled means that the volume delimited by the frame structure 35a and the outer shell 35b is substantially constant

In the embodiment shown in FIGS. 4a and 4b, the balloons 30 are arranged inside the torus-shaped rigid first housing 32, the rigid-walled tanks 12 and the compressor module 40 are arranged within the torus-shaped rigid second housing 33, and the housings 32, 33 comprises frame structures (not shown in the figures) made of carbon fiber and exterior shells made of Kevlar covering the frame structures. In this embodiment, the function of the support structure 20 is provided by the housings 32, 33, i.e. the space rocket 100 is connected to the housing 32 through the rigid-walled balloon 35. It is noted that embodiments in which the rigid-walled balloon 35 is connected to the housing 33 or the housings 32 and 33 may be conceivable. The housings 32, 33 are dimensioned so as to encircle the rigid-walled balloon 35 circumferentially, such that the rigid-walled balloon 35 can pass through the interior of the torus (see FIG. 4a).

In the following, some possible embodiments of the platform 10 according to the invention are illustrated by some hypothetical calculation examples

### Example 1

In this embodiment, the space rocket 100 is a Falcon 9 v1.0 booster with a mass of 335 tons. The platform 10 contains ten balloons 30 each of 150 meters in diameter, made of latex of 1 cm thickness. The balloons 30 are filled with hydrogen and weigh 161 tons each (including hydrogen). Ten aluminum rigid-walled tanks 12, each having a volume of 4.500 cubic meters, are attached to the support structure 20. The total weight of the carbon fiber support structure 20, the tanks 12 and the compressor module 40 is 150 tons. The total mass of the 10 platforms and the space rocket 100 is thus approximately 2,100 tons and the displaced volume is 17,700,000 cubic meters. That is, the average density of the system is 0.118 kg/cubic meter. The platform 10, together with the rocket 100, rises until the average density of the system equals the density of the air at that altitude. The 0.118 kg/cubic meter air density is the density which can be measured at 18.5 km above sea level, so the platform 10 and the rocket 100 according to this example will rise to 18.5 km.

### Example 2

In this embodiment, the space rocket 100 is a Saturn V launch vehicle weighing 2860 tons. The Saturn V is the most powerful rocket ever built to deliver 140 tons of payload to a low orbit. The platform 10 in this case also contains ten spherical balloons 30, each 150 meters in diameter, made of latex with a wall thickness of 1 centimeter. The balloons 30 are filled with hydrogen and weigh 161 tons per piece (including hydrogen). Ten aluminum tanks 12 are attached to the support structure 20, each having a volume of 4,500 cubic meters. The total weight of the carbon fiber support structure 20, the tanks 12 and the compressor module 40 is 150 tons. The total weight of the platform 10 and space rocket 100 is approximately 4,600 tons and the displaced volume is 17,725,000 cubic meters. Therefore, the average density of the system is 0.26 kg/cubic meter. The density value of 0.26 kg/cubic meter is the air density measured at an altitude of 13 km above sea level, i.e. the platform 10 and the rocket 100 according to the above example can rise to the bottom of the stratosphere at an altitude of 13 km.

### Example 3

In this embodiment, the platform 10 includes a cigar-shaped rigid-walled balloon 35. The inner balloon 37 is filled with hydrogen. It is 500 meters long and 50 meters in diameter and has a volume of approx. 1,150,000 cubic meters. The carbon fiber frame structure 35a is 700 meters long and 60 meters in diameter. The outer shell 35b is made of Kevlar and having a wall thickness of 2 centimeters. The weight of the rigid-walled balloon 35 is thus approx. 130 tons. In this case, the space rocket 100 is a Saturn V launch vehicle weighing 2,860 tons, and the platform 10 contains ten spherical balloons 30, each 150 meters in diameter, made of latex with a wall thickness of 1 centimeter. The total weight of the 30 balloons is 1610 tons. The combined weight of the carbon fiber support structure 20, the tanks 12 and the compressor module 40 in this embodiment is approx. 400 tons. The total weight of the platform 10 and the space rocket 100 is thus approximately 5,000 tons, and the displaced volume is 19,000,000 cubic meters. Thus, the average density of the system is 0.26 kg/cubic meter. The density value of 0.26 kg/cubic meter is equal to the air density measured at an altitude of 13 km above sea level, i.e. the platform 10 of the above example, together with the rigid-walled balloons 35 and space rocket 100, can rise up to the bottom of the stratosphere at an altitude of 13 km.

It is noted that in the above examples, the weights of the space rockets 100 which were used in the past or which are still being used were the weights that are calculated for launching from sea level. However, it is known, that a significant portion of the mass of the space rocket 100 is made up by the propellant. Therefore, in the case of launching from the stratosphere, due to the rarer atmosphere there and the higher potential energy, significantly less propellant is required to reach the same orbit. That is, a space rocket 100 having the same mass and launched from an altitude can orbit more payload as its counterpart launched from sea level, or less propellant is required to orbit the same mass of payload. This ultimately reduces the cost per useful unit mass.

The invention further relates to a method for launching rigid-walled balloons 35 into space. In the following, the operation of the platform 10 will be described in connection with the method of the present invention.

As mentioned, the rigid-walled balloons 35 have many applications in the space. In the case of hydrogen filling gas, for example, the hydrogen in the balloon 37 can be used as a propellant for spacecrafts or can be converted to water at space stations, while energy can be obtained from the chemical reaction. Due to its radiation-absorbing properties, hydrogen is excellent for use in radiation shields, which are much needed in space. The frame structure 35a and the shell 35b of the rigid-walled balloon 35 can be used, for example, to form structural elements of space stations or space hotels or, if appropriate, to build bases for other celestial bodies (e.g. on the Moon or Mars).

In the method according to the invention, the rigid-walled balloon 35 is fixed to the top of the space rocket 100 and is lifted together with the space rocket 100 by means of the floating platform 10 described above, in the following manner. After connecting the rigid-walled balloon 35 to the support structure 20, the inner balloon 37 and the one or more balloons 30 are filled with hydrogen or helium. As a result, the volume (i.e., air displacement) of the system increases and its density decreases. It is noted that the rigid balloon 35 increases the buoyancy of the platform 10, however, it alone would not be able to lift the space rocket 100 to a suitable height. The platform 10 may optionally be secured to the ground, for example by means of cables, while the inner balloon 37 or balloon 30 is being inflated, as will be apparent to those skilled in the art. Note that, if necessary, an embodiment is conceivable in which at least a portion of the hydrogen or helium required to fill the inner balloon 37 or balloon 30 is contained in the one or more rigid-walled tanks 12 and the inner balloon 37 or balloons 30 are filled as the platform 10 rises. In a particularly preferred embodiment, the rigid-walled balloon 35 and the space rocket 100 attached thereto are lifted to an altitude of at least 10,000 to 30,000 meters above sea level by means of the floating platform 10. At this altitude, the above-mentioned benefits of launching from high altitude are apparent. In a preferred embodiment, the position of the platform 10 can be stabilized and the platform 10 can be moved to the desired launching position by the one or more propulsion engines 25.

After reaching the maximum altitude using the floating platform 10, i.e. the height at which the buoyancy of the system formed by the platform 10 and the space rocket 100 is equal to the gravitational force acting on the system, the rigid-walled balloon 35 is disconnected from the floating platform 10 together with the space rocket 100 connected thereto, that is, the releasable connection between the rigid-walled balloon 35 and the support structure 20 is released. Before or after the disconnection, the engine of the space rocket 100 is started and the rigid-walled balloon 35 is launched into orbit by the space rocket 100. In the embodiment shown in FIGS. 3a and 3b, after disconnection, the space rocket 100 begins to sink with the rigid-walled balloon 35 attached thereto and move away from the platform 10. In this embodiment, it is important that the space rocket 100 move as far away from the platform 10 as possible so that the heat from the engines does not damage the balloons 30. In contrast, in the embodiments with covers 32, 33 shown in FIGS. 4a and 4b, it is not necessary for the space rocket 100 and the rigid balloon 35 to move downward relative to the platform 10 prior to launching the space rocket 100; the space rocket 100 may also pass through the platform 10 (see FIG. 4b). Namely, the housings 32, 33 made of Kevlar protect the balloons 30 from the heat of the engine of the space rocket 100. The engine of the space rocket 100 can thus be started before the disconnection. The advantage of launching the space rocket 100 through the platform 10 is that in this way no valuable altitude is lost as the space rocket 100 sinks, thereby saving fuel or increasing the radius of the orbit of the space rocket 100.

Once the space rocket 100 has been disconnected from the platform 10, a portion of the hydrogen or helium in the balloons 30 begins to be delivered to one or more tanks 12 by means of the compressor module 40. As a result, the volume of the one or more balloons 30 is reduced, i.e., the buoyancy of the platform 10 is reduced as well. By reducing the amount of hydrogen or helium in the one or more balloons 30, it is possible for the platform 10 to sink to the desired altitude or even sea level. By means of the one or more propulsion engines 25, the platform 10 can be returned to the launch site, for example to a ground center.

Various modifications to the above disclosed embodiments will be apparent to a person skilled in the art without departing from the scope of protection determined by the attached claims.

1. A floating platform (10) for launching a space rocket (100) from high altitude comprising a support structure (20) for suspending the space rocket (100) releasably connected to the space rocket (100), the floating platform (10) further comprising at least one hydrogen or helium filled balloon (30) fixed to the support structure (20), at least one rigid-walled tank (12) and a compressor module (40) connected to the balloon one or more balloons (30) and the rigid-walled tank (12) for delivering at least a portion of the hydrogen or helium stored in the balloon (30) into the rigid-walled tank (12), said balloon (30) being dimensioned so as to lift the floating platform (10) and the space rocket (100) connected thereto, characterized in that the floating platform (10) comprises a hydrogen or helium-filled, rigid-walled balloon (35) which is releasably connected to the support structure (20), which is attachable to a top portion of the space rocket (100) and which is adapted to connect the space rocket (100) to the support structure (20).

2. The floating platform (10) according to claim 1, characterized in that the balloon (30) is arranged inside a rigid toroidal-shaped first housing (32) and the rigid-walled tank (12) and the compressor module (40) are arranged inside a rigid toroidal-shaped second housing (33).

3. The floating platform (10) according to claim 2, characterized in that the first and second housings (32, 33) comprise frame structures defining shape of the first and second housings (32, 33), and comprise outer shells covering the frame structures.

4. The floating platform (10) according to claim 2, characterized in that the first and second housings (32, 33) are arranged in such a way that they contact each other.

5. The floating platform (10) according to claim 1, characterized in that the support structure (20) is ring-shaped and a plurality of balloons (30) is arranged spaced at equal distances along the circumference of the ring.

6. The floating platform (10) according claim 1, characterized in that the support structure (20) is hollow and the rigid-walled tank (12) and the compressor module (40) are arranged inside the support structure (20).

7. The floating platform (10) according to claim 1, characterized in that the rigid-walled balloon (35) comprises a frame (35a), defining the shape of the rigid-walled balloon (35), one or more hydrogen or helium-filled inner balloons (37) arranged inside the frame structure (35a) and an outer shell (35b), covering the frame structure (35a).

8. The floating platform (10) according to claim 1, characterized in that the balloon one or more balloons (30) is dimensioned to lift the floating platform (10) and the space rocket (100) connected thereto to an altitude of at least 10,000 to 30,000 meters above sea level.

9. The floating platform (10) according to claim 1, characterized in that the balloon (30) is made of a flexible material.

10. The floating platform (10) according to claim 1, characterized in that at least one propulsion engine (25) for maneuvering the floating platform (10) is connected to the support structure (20).

11. Floating platform (10) according to claim 10, characterized in that it comprises a navigation module for determining the geographical position of the platform (10) and a central IT unit connected to the navigation module for controlling the at least one propulsion engine (25).

12. A method of launching a rigid-walled balloon (35) into space, comprising:
attaching the rigid-walled balloon (35) to a top portion of a space rocket (100), and lifting the rigid-walled balloon (35) together with the space rocket (100) with a floating platform (10) according to claim 1,
at the maximum height achievable by means of the floating platform (10), separating the rigid-walled balloon (35) and the space rocket (100) attached thereto from the floating platform (10),
starting the engine of the space rocket (100) and moving the rigid-walled balloon (35) into orbit around Earth.

13. The method according to claim 12, characterized in that the rigid-walled balloon (35) and the space rocket (35) connected thereto are lifted to an altitude of at least 10,000 to 30,000 meters above sea level by means of the floating platform (10).

14. The floating platform according to claim 1 wherein said rigid-walled balloon is cigar-shaped.

15. The floating platform according to claim 3 wherein said frame structures are made of carbon fiber and said outer shells are made of Kevlar (poly-paraphenylene terephthalamide).

16. The floating platform according to claim 7 wherein said frame defining the shape of the rigid-walled balloon is made of carbon fiber and said outer shell is made of Kevlar (poly-paraphenylene terephthalamide).

17. The floating platform according to claim 9 wherein said balloon is made of latex.
